(19) United States
(12) Patent Application Publication
(10) Pub. No.: US 2023/0235503 A1
(43) Pub. Date: Jul. 27, 2023

(54) DEVICE AND METHOD FOR PRODUCING A MOLDED BODY FROM A FIBER MATERIAL

(71) Applicant: Alexander KARL, Ulm (DE)

(72) Inventor: Alexander KARL, Ulm (DE)

(21) Appl. No.: 18/009,177

(22) PCT Filed: Jun. 14, 2021
(86) PCT No.: PCT/EP2021/065918

§ 371 Date: Dec. 8, 2022

(30) Foreign Application Priority Data
Jun. 10, 2020 (DE) 10 2020 115 394.5

(51) Int. Cl. D06M 23/14

(52) U.S. Cl. CPC D06M 23/14

(57) ABSTRACT

The invention relates to a method (30) for producing a molded body (52) from a fiber material (50), wherein a textile structure (54) that is provided with a binder material is first produced from the fiber material (50) using a textile technology (step 32). This textile structure (54) is subsequently shaped (step 34) and fixed in a predetermined three-dimensional form by an activation of the binder material (step 36). The activation of the binder material (step 36) is carried out iteratively here. This means that the binder material is activated progressively in some selected areas of the textile structure (54) (and the shape of the structure is fixed in these areas as a result) before an activation/fixing is carried out in other areas of the textile structure (54).

The invention relates to a device and a method for producing a molded body from a fiber material.

In view of rising costs for raw materials and energy, carbon fibers are increasingly in demand as substitute materials for traditional materials on account of their mechanical and functional properties. Carbon fiber reinforced structural components have very high strength while at the same time having a low weight. In this regard, stringent requirements are placed on the quality and processing characteristics of the components to be made from carbon fibers, especially in aerospace and in the automotive industry.

Methods are used in the production of fiber reinforced plastic components, in particular fiber reinforced structural components, in which a semifinished fiber product that is provided with a binder material is first formed into a fiber parison (preform) in a preform mold; the binder material is activated by the action of heat in the preform mold, and in this way the three-dimensional shape of the preform is fixed. During this process, the fiber orientation, for example, of the fiber parison is set. The preform is then infiltrated with a resin by means of an infusion process (resin transfer molding (RTM) or vacuum assisted resin infusion (VARI), for example), and the resin is then hardened by the action of heat. The heating of the semifinished fiber product or of the fiber parison is normally accomplished by means of a heater integrated in the preform mold or in the infusion mold.

The term “fiber material” should be understood here to mean any textile starting material whose fibers are provided with a curable binder material. A sheetlike textile structure, in particular a woven fabric, knitted fabric, braid, etc., is produced from this fiber material and made into a three-dimensional shape. This three-dimensional shape is then fixed by a curing process in which the binder material is activated. Traditionally this curing takes place in a shaping mold. The textile structure that constitutes the starting material for producing the preform will typically be produced using a weaving process. Such a textile structure is present, in particular, as a sheetlike fiber mat, which is trimmed to the desired shape prior to shaping in the preform mold.

It is often problematic in the three-dimensional shaping of flat fiber mats that wrinkles, which adversely affect the quality of the finished component, can form during draping.

Furthermore, draping can only be implemented in automated process steps at great expense. In addition, there is often a desire to provide selected areas of the component being produced with reinforcements, connection elements, etc. or to design the component in such a way that certain anisotropic tensile strengths etc. are present. In order to make this possible, methods for three-dimensional weaving of fiber materials have been developed. Thus, methods for 2D weaving and for 3D weaving, the use of which allows a box structure to be produced from fiber composite material, are described in DE 10 2011 088 472 B3, for example. With the aid of the methods described there, areas of the fiber construct can also be woven with different thicknesses, in particular. A three-dimensional preform weave structure in which a layer-to-layer interlocking is achieved through a complex, multilayer weaving process is known from DE 602 21 236.

If a fiber-reinforced structural component is to be made from such a complex, three-dimensional woven structure, then the problem arises of placing the structure in a preform mold or an infusion mold in such a manner that a high-quality component with the desired characteristics is produced therefrom. On account of the complex geometry of the woven structure, this requires many operations, some of which are manual, which makes the production of such a fiber composite component difficult, costly, and time-consuming.

The object of the present invention is to propose a method for producing a molded body from a fiber material whereby the abovementioned problems can be avoided. In addition, it is the object of the invention to create a device whereby such fiber molded bodies can be produced.

These objects are attained by a method and a device with the features of the independent claims. The dependent claims relate to advantageous improvements and variants of the invention.

The method according to the invention provides that a textile structure is first produced from the fiber material by means of a textile technology in an assembly unit. The textile structure is provided with a binder material, wherein the binder material can either have been applied to the fiber material before the textile processing or be applied to the fiber material during or after the textile processing. The textile structure is subsequently formed three-dimensionally in a predetermined manner in a forming step, and the forming of the textile structure thus created is fixed through activation of the binder material. The activation of the binder material is carried out iteratively here according to the invention. “Iterative” activation should be understood here to mean that the binder material is activated progressively in some selected areas of the textile structure (and the shape of the structure is fixed in these areas as a result) before an activation/fixing is carried out in other areas of the textile structure.

In contrast to the preforming methods known from the prior art, in which fiber mats are fixed in shape in a single process step in a preforming mold, the fixing is thus carried out area-by-area or section-by-section in the method according to the invention. In this case, a selected area of the textile structure is first brought into the desired shape by a shaping and then fixed by the activation of the binder material. In doing so, adjacent areas, in particular, can be formed and fixed in such a sequence that a wrinkling of the fiber mats is prevented effectively. The basic idea of the method according to the invention thus consists of progressively and locally curing the textile structure immediately after its production and positioning the already-hardened areas during the curing process such that the part of the textile structure to be cured is in the correct/desired position/orientation. In this case the already hardened areas stabilize the three-dimensional shape of the areas that have already been completed, thus supporting the shaping process.

Advantageously, the iterative activation of the binder material is carried out in-process, which is to say overlapping in time with the production of the textile structure by a textile process, so that the textile structure emerging from the assembly unit is shaped and fixed area-by-area while other areas of the structure are still undergoing the production process in the assembly unit. This makes it possible, in particular, to produce three-dimensionally shaped fiber composite molded bodies in a continuous operation in which the textile structure emerging from the textile processing system is shaped and fixed in-process—possibly with a certain time difference or spatial difference. In this case, influence can be exerted on the assembly unit, in particular by the fixing unit, in that the textile tension in specific areas is set higher or lower; in this way, wrinkling, for example, and/or internal stresses in the textile structure can be prevented or at least reduced. This textile tension can likewise be reduced for the positioning/orienting of the textile structure as well so that a “turning” of the structure is made possible.

Advantageously, the shaping of the textile structure is also carried out such that it overlaps in time with the fixing of the binder material. In this process, the textile structure is brought into the desired three-dimensional shape locally, for example, and cured locally by activation of the binder material contained in the textile structure. The area that is hardened in this way is thus fixed in the desired shape, and as a result forms a support for other areas that are to be shaped and fixed.

It is especially advantageous when the shaping of the textile structure and the fixing of the shaped areas are carried out synchronously with the production of the textile structure. In this way a continuous process consisting of production, shaping, and fixing can be achieved. A multitude of different molded bodies can thus be produced in continuous operation on a single system by means of appropriately coordinated control of the textile production process, the shaping, and the fixing. This provides high flexibility and an ability to automate the process as a whole. In this way, adaptation of geometry can be simplified substantially and even extremely short runs can be produced economically in comparison with conventional preforming methods, in which a textile structure is shaped and fixed in a geometrically fixed preforming mold.

The shaping of the textile structure preferably is carried out with the aid of manipulators, which can be designed as movable punches, grippers, etc. These manipulators can be positioned and actuated with the aid of industrial robots, in particular. Furthermore, tools can be employed that consist of a multiplicity of movable dies, hold-downs, etc. By means of suitable programming of the manipulators, the textile structure can be shaped in many ways in order to produce fiber molded bodies with an extremely wide variety of geometries in an automated manner. Furthermore, the programming of the manipulators can be modified quickly to achieve changes in the geometry of the molded bodies to be produced. The programming could even be carried out during the entire process—modifications or programming could thus be undertaken as long as the fiber molded body has not yet reached the area to be changed. In addition or alternatively, the programming/modification could be carried out between the production of individual fiber molded bodies.

The textile structure can be, in particular, a woven fabric that was produced with the aid of a weaving process. Woven fabrics are flat structures that consist of two thread systems, warp threads and weft threads, that cross in a patterned manner. The warp threads run in the longitudinal direction of the fabric, parallel to the selvage, and the weft threads in the crosswise direction, parallel to the cloth fell. In addition to the production of simple, flat woven fabrics, weaving methods with which fiber constructs of varying thickness can be woven are also known from the prior art. Furthermore, complex multilayer weaving methods with layer-to-layer interlocking and methods for weaving in three dimensions are known. Thus, a wide range of textile structures can be produced through the use of a suitable weaving technology.

The textile structure woven in this way can then be locally cured, for example area-by-area or immediately after each weaving step, and the already woven and cured area can be positioned in such a manner during the curing process that the area to be newly cured is in the correct position/orientation. The invention thus makes it possible to produce complex, woven, three-dimensionally shaped structures from a fiber material.

The activation of the binder material can, in particular, be accomplished by electromagnetic radiation, in particular by infrared radiation. In this case, the area of the textile structure to be fixed is heated with the aid of an infrared source. If the binder material is a thermoplastic material, in particular a thermoplastic powder, it is melted by the heat and solidifies on cooling, fixing the local shape of the textile structure in the process. If the binder material is a thermoset, a cross-linking reaction is initiated by the action of heat, by which means the shape is fixed.

If the textile structure contains electrically conductive fibers (e.g., carbon fibers), then the activation of the binder material can also be accomplished by electric current. In this case, selected electrically conductive fibers of the textile structure are connected to a current source. Heating takes place in the area of crossing points of the fibers that are supplied with current in this case. The strength of the current is chosen such that the temperature in the area of the crossing points is high enough that the binder material melts or is cross-linked and the three-dimensional shape of the textile structure there is fixed.

The activation of the binder material can also be accomplished by chemical means, in particular by the application of a substance with appropriate action, for example in the manner of a hardener.

A device according to the invention for producing a molded body includes an assembly unit with a textile processing system in which a textile structure is produced from a fiber material. The textile processing system can, in particular, be a weaving machine, for example a single phase weaving machine.

In addition, the device includes a fixing unit for iterative spatial fixing of the textile structure emerging from the textile processing system.

The fixing unit advantageously contains a shaping unit whereby the textile structure emerging from the textile processing system can be spatially shaped in a predetermined manner before the shape created in this way is permanently fixed.

This shaping unit can include a multiplicity of manipulators that can be moved and activated under closed- and/or open-loop control, in particular grippers, jaw grippers, punches, etc., which act on the textile structure emerging from the textile processing system. In order to achieve good accessibility and high flexibility in the shaping of the textile structure, at least some of the manipulators can be guided and actuated with the aid of industrial robots. Direct use of a robot as a manipulator is also possible.

The fixing unit further includes an activation unit for activating the binder material contained in the textile structure. The activation unit can include an electromagnetic radiation source, for example. If the textile structure includes electrically conductive fibers (or wires), then the activation unit can also include an electric current source whereby selected fibers/wires can be supplied with current.

Exemplary embodiments and variants of the invention are explained in detail below on the basis of the drawings. They show:

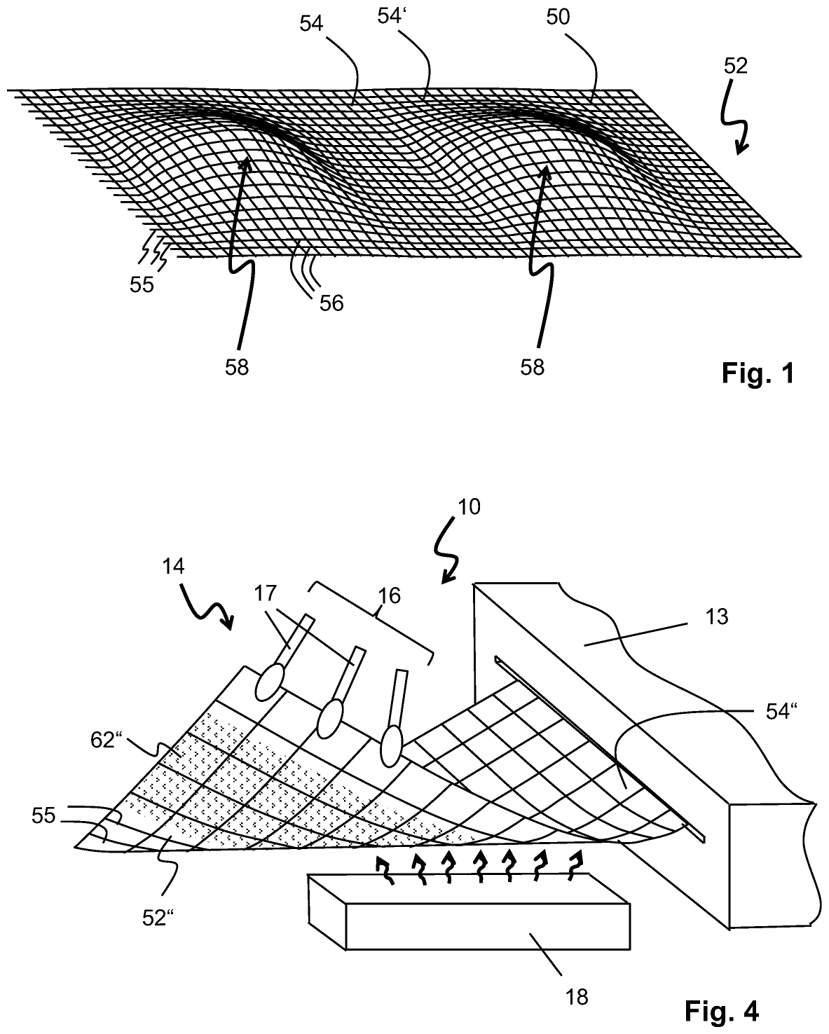

FIG. 1 a perspective view of a molded body made from a fiber material;

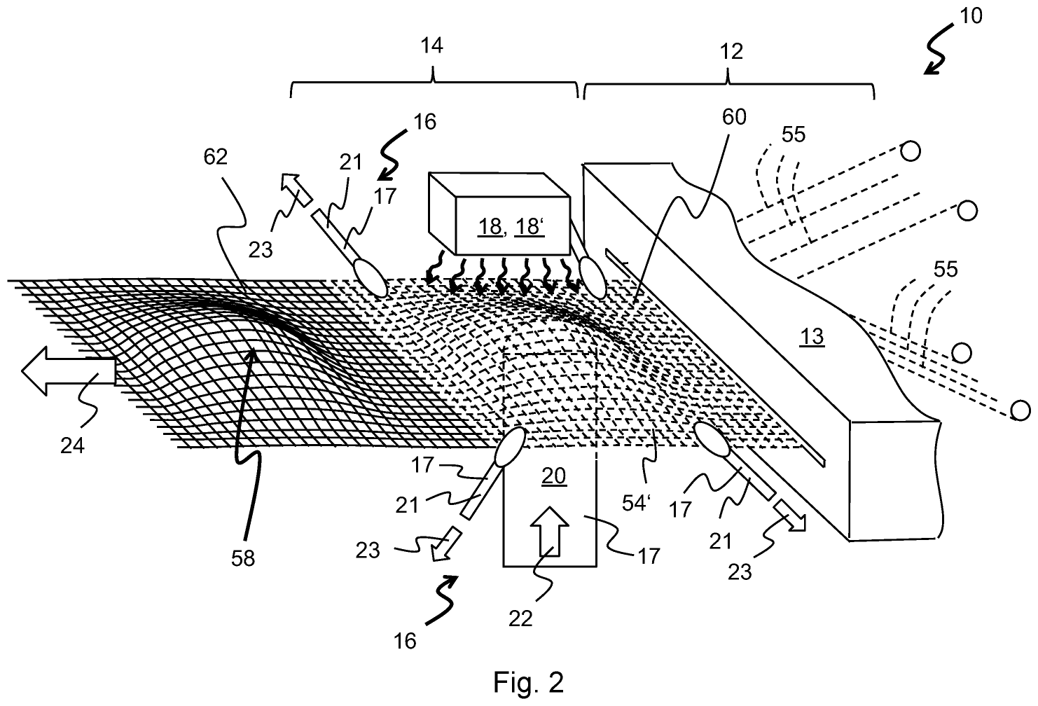

FIG. 2 a schematic representation of a device for producing the molded body from FIG. 1;

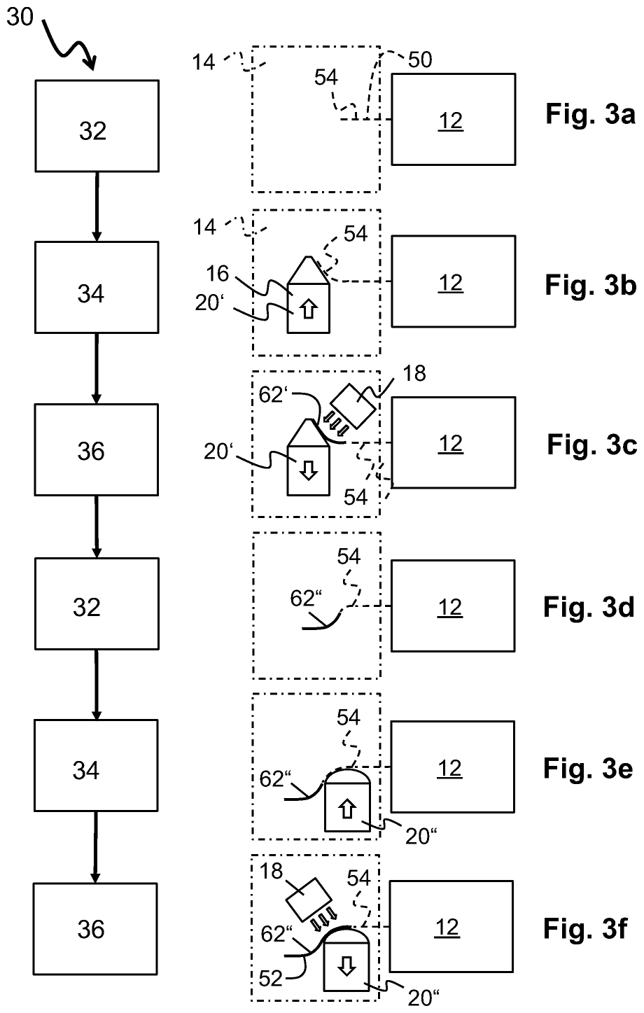

FIGS. 3a-3f a schematic representation of a sequence of operations according to the invention for producing a molded body from a fiber material;

FIG. 4 a schematic representation of an alternative device for producing a molded body.

FIG. 1 shows, in a perspective view, a molded body 52 made from a fiber material 50. A carbon fiber roving can be used as fiber material 50, for example. The molded body 52 consists of a flat textile structure 54, which was produced by a weaving process known from the prior art and then formed. The textile structure 54 is thus a woven fabric 54′ with interwoven warp threads 55 and weft threads 56 made of fiber material 50. For reasons of clarity, only isolated warp and weft threads 55, 56 are shown in FIG. 1 here.

The molded body 52 is a dimensionally stable structure that has two domelike curves 58. Such a molded body 52 can be used, for example, as a preform for producing a fiber-reinforced composite component. In this case, the molded body is infiltrated with a resin in a subsequent step with the aid of an infusion process (resin transfer molding (RTM) or vacuum assisted resin infusion (VARI), for example), and the resin is then cured by the action of heat.

For producing the molded body from FIG. 1, a device 10 is employed that is shown in a schematic representation in FIG. 2. The device 10 includes a schematically indicated assembly unit 12 with a weaving machine 13, by means of which the woven fabric 54′ is produced. Some of the warp threads 55 are schematically indicated in the interior of the weaving machine 13.

The woven fabric 54′ is provided with a thermoplastic binder material, which can be thermally activated repeatedly, becomes soft under the action of heat, and solidifies again after cooling. The binder material is thus formable in the heated state, and the shape imposed by the shaping is “frozen” upon cooling. The binder material can be applied to the woven fabric 54′ in the form of a thermoplastic powder, for example during the course of or immediately after the production of the woven fabric 54′ in the weaving machine 13; alternatively, the fiber material of the warp threads 55 and/or the of weft threads 56 can have already been provided with the binder material prior to the weaving process.

On leaving the weaving machine 13, the woven fabric 54′ (area 60) has a slack, flat form, which is symbolized by a dashed representation of the warp and weft threads 55, 56. After leaving the weaving machine 13, the slack woven fabric 54′ arrives in a fixing unit 14, where it is brought into the desired three-dimensional shape and fixed. The fixing unit 14 includes a shaping unit 16, by means of which the fabric 54′ emerging from the weaving machine 13 can be shaped three-dimensionally. In the present exemplary embodiment, the domelike curve 58 is to be molded into the woven fabric 54′. To this end, the shaping unit 16 includes multiple manipulators 17, which are composed of a movable punch 20 and multiple grippers 21 in the present case. The grippers 21 grip the woven fabric 54′ at the sides and tauten it (arrows 23), while the punch 20, acting from below, bulges the woven fabric 54′ in the middle (arrow 22). The woven fabric 54′ is thus pulled over the punch 20 with the aid of the grippers 21, and the woven fabric 54′ is brought into the desired shape by the simultaneous application of force by the punch 20 and the grippers 21 (arrows 22, 23). In order to minimize a displacement of the fibers in the woven fabric 54′ in the event of strong bulging and shaping, the warp threads 55 in the weaving unit 13 are flexibly suspended in such a manner that they can yield in the event of strong (local) exertion of tensile forces by the shaping unit 16. In this context, the tension of the warp threads 55 can be set under closed- or open-loop control in such a manner that a required density and stability of the woven fabric 54′ is achieved on the one hand, but on the other hand a certain amount of play is present in order to avoid wrinkling of the woven fabric 54′ during the shaping.

If the desired three-dimensional shape has been achieved in a selected area of the woven fabric 54′, then this shape is permanently fixed with the aid of an activation unit 18 integrated in the fixing unit 14. In the present exemplary embodiment, the activation unit 18 is an infrared source 18′ whereby the selected areas of the woven fabric 54′ can be heated. The thermoplastic binder material contained in the woven fabric 54′ is melted by the heating and solidifies upon cooling in the shape molded in the woven fabric 54′ by the shaping unit 16, by which means this three-dimensional shape is “frozen” and thus fixed.

In an area 62 of the woven fabric 54′ more distant from the weaving machine 13, this shape is already “frozen,” which is symbolized by a representation of the warp and weft threads in solid lines. In this area 62, the woven fabric 54′ that was shaped in an earlier process step is already fixed in the shaped form, and thus no longer requires manipulators 17 to hold the woven fabric 54′ in this area 62 in shape. As the weaving process progresses, the woven fabric 54′ produced by the weaving machine 13 is thus transported in the direction of the fixing unit 14, where it is locally shaped and fixed in shape and then transported onward (arrow direction 24). Shown in FIG. 2 is a snapshot in which some areas 60 of the woven fabric 54′ are already fixed in shape while other areas 60 are still limp and unshaped.

FIGS. 3a-3f show, in a schematic representation, a sequence of operations 30 for producing a molded body from a fiber material 50. The production of a textile structure 54 is carried out (continuously or progressively) using a textile process in the assembly unit 12 (method step 32, FIG. 3a). The textile structure 54 emerging from the assembly unit 12 is limp at first, which is represented by a dashed line. The textile structure 54 arrives in the fixing unit 14, where it is first shaped with the aid of a shaping unit 16, wherein a punch 20′ is symbolically represented as a forming tool (method step 34, FIG. 3b). The area of the textile structure 54 shaped by means of the punch 20′ is subsequently fixed in this shaped state with the aid of the activation unit 18 (method step 36, FIG. 3c). In this process, a binder material contained in the textile structure 54 is cured, for example with a use of electromagnetic radiation, by which means the textile structure 54 is now flexurally stiff in this area and the curve molded by the punch 20′ is “frozen”. The fixed part 62′ of the textile structure 54 is indicated by a solid line in FIG. 3c.

Another section of limp textile structure 54 is now produced by the assembly unit 12 (method step 32, FIG. 3d), which arrives in the fixing unit 14 and is shaped with the use of another punch 20″ (method step 34, FIG. 3e). The area of the textile structure 54 shaped by means of this punch 20″ is subsequently fixed in turn in this shaped state with the aid of the activation unit 18 (method step 36, FIG. 3f). FIGS. 3a-3f thus show a sequence of operations 30 in which the production (step 32), shaping (step 34), and fixing in shape (step 36) of the textile structure 54 are carried out area-by-area and progressively in sequence. However, the method steps can advantageously overlap in time, so that, for example, the production (step 32) is carried out continuously and shaping (step 34) and fixing in shape (step 36) are carried out in synchronization with production (step 32). Furthermore, shaping (step 34) and fixing in shape (step 36) can also overlap in time, for example in that the limp woven fabric 54 is continuously formed with the aid of manipulators 17 (step 34) and the fixing (step 36) is carried out in sections synchronously therewith.

In the exemplary embodiment shown in FIG. 4, a method is used for producing a molded body 52″ in which the process step of producing the woven fabric 54′ (step 32) overlaps continuously with the process steps of shaping (step 34) and fixing (step 36): Here, a woven fabric 54″ emerging continuously from the weaving machine 13 is not only tensioned and shaped with the aid of manipulators 17, which have the form of robot-guided grippers, but also draped three-dimensionally in space. The warp threads 55 (of which only a few are represented in FIG. 4) always run linearly in this case; the actual “rotating” of the object formed from the woven fabric 54″ is done by the manipulators 17. With the aid of the activation unit 18, selected areas of the woven fabric 54″ formed by the manipulators 17 are fixed continuously and in synchronization with the emergence of the woven fabric 54″ from the weaving machine 13. The areas 62″ fixed in this manner are represented with dots in FIG. 4. With the aid of the method shown in FIG. 4, any desired three-dimensionally shaped molded bodies 52″ can be produced, which, in particular, can have undercuts or can even be designed as spatially closed hollow bodies. Production of such molded bodies 54″ is not possible using conventional preforming methods, in which the woven fabric 54″ is placed in a fixed mold and shaped and fixed as a whole.

In the exemplary embodiments from FIGS. 1 to 3, the fixing of the shaped woven fabric 54, 54′, 54″ is carried out by heating with the aid of an electromagnetic radiation source, for example by infrared radiation or by UV radiation (when a thermosetting resin is used as binder material, for example).

If at least some of the warp and weft threads are electrically conductive, then the heating can also be accomplished by means of electric current. In this case, an electric current is applied to selected warp threads 55 and weft threads 56. The strength of the current is chosen in such a way that sufficient heating for activating the binder material is achieved in the area of the crossing points of the fibers 55, 56 that are supplied with current; in these areas, therefore, the binder material is melted and solidifies after cooling in the three-dimensional shape molded by the manipulators. The area where the binder material is to be activated can be defined very precisely by the choice of the fibers that are supplied with current, so that well-defined local curing takes place.

Activation by means of electric current has the advantage that even fiber structures that are opaque to electromagnetic radiation, which is to say that can only be surface-hardened with the aid of a radiation source, can be cured in this way. In the case of activation by means of electric current, however, only areas in which the fibers are incorporated in the woven fabric (i.e., have crossing points with other fibers) can be fixed, in contrast to activation by means of electromagnetic radiation.

Alternatively to the thermoplastic binder material described in the exemplary embodiments, a thermosetting binder material can be used. Such a thermosetting binder can, in particular, be applied in liquid form to the fibers before the fibers are made up into the textile structure 54. The activation of the thermosetting binder is carried out with the aid of UV radiation, for example; in this case, the activation unit is designed as a UV source.

In the exemplary embodiments from FIGS. 1 to 4, the invention was explained on the basis of a flat woven fabric 54, 54′, 54″. As a result of using a 2.5-dimensional or 3-dimensional weaving process, however, the woven fabric can also have a more complex form, for example be a multilayer construction with interconnected layers of fabric, a box structure or honeycomb structure, etc.

Furthermore, any other textile, for example a knitted textile, a felt, a braid, etc., can be used in place of the woven fabric.

### LIST OF REFERENCE SYMBOLS

10 Device

12 Assembly unit

13 Weaving machine

14 Fixing unit

16 Shaping unit

17 Manipulator

18 Activation unit

20 Punch

21 Gripper

22-24 Arrows

30 Sequence of operations

32 Method step: textile processing (production of textile structure)

34 Method step: shaping

36 Method step: binder activation

50 Fiber material

52, 52′ Molded body made of fiber material

54 Textile structure

54′ Woven fabric

55 Warp threads

56 Weft threads

58 Domelike curves

60 Area after leaving the weaving machine (slack)

62 Fixed area of the woven fabric

1. A method for producing a molded body from a fiber material, the method comprising: wherein
providing a textile structure with a binder material is produced from the fiber material using a textile technology;
shaping the textile structure; and
fixing the shaped textile structure in a predetermined three-dimensional form by an activation of the binder material
wherein the activation of the binder material is carried out iteratively.

2. The method according to claim 1, wherein the activation of the binder material is carried out in-process during production of the textile structure.

3. The method according to claim 1, wherein the shaping of the textile structure and the activation of the binder material overlap in time.

4. The method according to claim 1, wherein the shaping of the textile structure (step 34) and the activation of the binder material (step 36) are carried out in synchronization with the production of the textile structure (step 32).

5. The method according to claim 1, wherein the shaping of the textile structure is carried out using an industrial robot.

6. The method according to claim 1, wherein the textile structure is produced by means of a weaving technology.

7. The method according to claim 1, wherein the activation of the binder material is accomplished by electromagnetic radiation.

8. The method according to claim 1, wherein the activation of the binder material is accomplished by electric current.

9. A device for producing a molded body from a fiber material, the device comprising:
an assembly unit for producing a textile structure that is provided with a binder material from the fiber material; and,
a fixing unit for geometrical fixing of the textile structure emerging from the assembly unit.

10. The device according to claim 9, wherein the fixing unit includes a shaping unit for spatial forming of the textile structure from fiber material.

11. The device according to claim 10, wherein the shaping unit includes at least one industrial robot.

12. The device according to claim 9, wherein the fixing unit includes an activation unit for activating a binder material contained in the textile structure.

13. The device according to claim 12, wherein the activation unit includes an electromagnetic radiation source.

14. The device according to claim 12, wherein the activation unit includes an electric current source.

15. The device according to claim 9, wherein the assembly unit includes a weaving machine.

16. The device according to claim 15, wherein the weaving machine is a single phase weaving machine.
